(19) United States
(12) Patent Application Publication
(10) Pub. No.: US 2013/0151215 A1
(43) Pub. Date: Jun. 13, 2013

(54) RELAXED CONSTRAINT DELAUNAY METHOD FOR DISCRETIZING FRACTURED MEDIA

(71) Applicant: Schlumberger Technology Corporation, Sugar Land, TX (US)

(72) Inventor: Hussein Mustapha, Abingdon (GB)

(73) Assignee: SCHLUMBERGER TECHNOLOGY CORPORATION, Sugar Land, TX (US)

(21) Appl. No.: 13/709,701

(22) Filed: Dec. 10, 2012

Related U.S. Application Data
(60) Provisional application No. 61/569,443, filed on Dec. 12, 2011.

(51) Int. Cl. G06F 17/17

(52) U.S. Cl. CPC G06F 17/17
USPC 703/2

(57) ABSTRACT

Systems and methods for modeling a fractured medium are provided. The method includes discretizing fractures in a representation of the fractured medium, with the discretizing including defining points along the fractures and edges extending between adjacent points. The method also includes determining that at least one of the edges is a non-Gabriel edge, and removing the non-Gabriel edge from the representation. The method further includes approximating the removed non-Gabriel edge to generate an approximated edge, and inserting the approximated edge into the representation.

### CROSS-REFERENCE TO RELATED APPLICATION

This application claims priority to U.S. Provisional Patent Application having Ser. No. 61/569,443, filed on Dec. 12, 2011. The entirety of this priority application is included herein by reference.

### BACKGROUND

Petroleum reservoirs, aquifers, and other geological features are often highly heterogeneous in composition and generally include preferential flow paths resulting from natural fracture networks formed therein. Simulating the flow of fluid in these features can provide valuable information to, for example, well operators, drilling service provides, etc.

Various modeling techniques are employed to perform such flow simulations. Examples of modeling techniques include dual-porosity and dual-permeability, single porosity, and discrete fracture modeling. Discrete fracture models have recently been recognized as an important vehicle for flow simulations in fractured media, providing a powerful tool for fractured reservoir characterization. In a typical discrete fracture model, multiple fractures are represented in n−1 dimensions, with the model being represented overall in n-dimensions. This simplification is generally considered to provide a beneficial tradeoff between accuracy and efficiency, i.e., conservation of computing resources, as the aperture (flowpath area) of the fractures is generally small relative to each element or “block” of the model. Accordingly, in a three-dimensional block model, the fractures are each represented as two-dimensional facets, while two-dimensional models represent fractures as edges. Furthermore, in such two-dimensional models, the edges representing the fractures are typically each characterized by center coordinates, orientation, hydraulic permeability, and aperture distribution.

To employ such discrete fracture modeling, the geological feature is generally discretized, forming a mesh or grid to enable characterization of the fracture network. However, the geometry of the fracture network within the fractured media is often complex and traditional techniques of grid generation may not be practical. In response to this challenge, practical approximation approaches are used to characterize the fractures in the grid. One such approach is known as “global approximation” and proceeds by non-constrained grid generation of the porous media and then approximation of the fracture elements. In this approach, structured and unstructured matching grids are generated for the matrix, neglecting the fractures, and then the fracture edges (in two-dimensional models) are approximated using the nearest matrix edges. While this approach has proven suitable for a variety of applications, its accuracy depends on the grid base used and generally does not allow for local grid refinement.

Another approximation approach uses constrained Delaunay triangulation to approximate the fracture within the grid. However, the fracture elements may violate the main characteristics of the triangulation, leading to a low mesh quality and potentially degenerate triangles in the mesh. Post-processing and refinement techniques are sometimes employed to account for such challenges; however, in complex fractured media simulations, such post-processing and refinement techniques may not be practical.

What is needed, then, are improved systems and methods for generation of boundary-conforming mesh of a computation domain defined by several constraining fracture edges that are spatially heterogeneous and closely distributed.

### SUMMARY

Embodiments of the disclosure may provide a method for modeling a fractured medium. The method includes discretizing fractures in a representation of the fractured medium, with discretizing including defining points along the fractures and edges extending between adjacent points. The method also includes determining that at least one of the edges is a non-Gabriel edge, and removing the non-Gabriel edge from the representation. The method further includes approximating the removed non-Gabriel edge to generate an approximated edge, and inserting the approximated edge into the representation.

Embodiments of the disclosure may also provide a system for modeling one or more fractured media. The system includes a processor system including one or more processors, and a memory system including one or more computer-readable media. The one or more computer-readable media contain instructions that, when executed by the processor system, are configured to cause the system to perform operations. The operations include discretizing fractures in a representation of the fractured medium, with discretizing including defining points along the fractures and edges extending between adjacent points. The operations further include determining that at least one of the edges is a non-Gabriel edge, and removing the non-Gabriel edge from the representation. The operations also include approximating the removed non-Gabriel edge to generate an approximated edge, and inserting the approximated edge into the representation.

Embodiments of the disclosure may further provide a computer-implemented method. The method includes modeling a fractured media comprising a network of fractures in a model using a processor, with the fractures represented as discretized elements. Each of the discretized elements defines points separated by a mesh step, with a segment extending between each of the points. The method further includes applying a Gabriel criteria to at least a portion of the model using the points on at least one of the discretized elements, and determining that at least one segment between two points on the at least one discretized segment does not meet the Gabriel criteria. The method also includes removing the at least one segment from consideration in the model, and approximating the at least one segment using a grid triangulation.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a flowchart of a method for discretizing one or more fractured media, according to an embodiment

FIG. 2 illustrates two discretized, intersecting fractures, which may be two among a complex network of fractures, according to an embodiment.

FIG. 3 illustrates a low-quality triangle generated by triangulating the discretization of the two intersecting fractures, according to an embodiment.

FIG. 4A illustrates the two discretized fractures with a modified Delaunay analysis applied thereto, according to an embodiment.

FIG. 4B illustrates the results of the modified Delaunay analysis shown in FIG. 4A, according to an embodiment.

FIG. 5 illustrates the discretized, intersecting fractures with non-conforming segments of one of the fractures removed, according to an embodiment.

FIG. 6 illustrates a local refinement process being applied to the discretized fractures, according to an embodiment.

FIG. 7 illustrates the two discretized, intersecting fractures with the removed, non-conforming segments being approximated, according to an embodiment.

FIG. 8 illustrates a schematic view of a processor system, according to an embodiment.

FIG. 9A illustrates an experimental example of the first and second fractures being discretized and triangulated using a traditional discretization method and a first mesh step ratio.

FIG. 9B illustrates an experimental example of the first and second fractures being discretized and triangulated using an embodiment of the method of FIG. 1 and the first mesh step ratio.

FIG. 10A illustrates an experimental example of the first and second fractures being discretized and triangulated using a traditional discretization method and a second mesh step ratio.

FIG. 10B illustrates an experimental example of the first and second fractures being discretized and triangulated using an embodiment of the method of FIG. 1 and the second mesh step ratio.

FIG. 11A illustrates an experimental example of the first and second fractures being discretized and triangulated using a traditional discretization method and a third mesh step ratio.

FIG. 11B illustrates an experimental example of the first and second fractures being discretized and triangulated using an embodiment of the method of FIG. 1 and the third mesh step ratio.

FIGS. 12 and 13 illustrate average, minimum, and maximum oil recoveries at one pore volume injected for 100 realizations in a Monte Carlo simulation, according to an experimental embodiment.

FIG. 14 illustrates average, minimum, and maximum CPU time for one pore volume injected for 100 realizations in a Monte Carlo simulation, according to an experimental embodiment.

FIG. 15 illustrates grid quality using different mesh step ratios of an experimental embodiment of the method, according to an embodiment.

### DETAILED DESCRIPTION

The following detailed description refers to the accompanying drawings. Wherever convenient, the same reference numbers are used in the drawings and the following description to refer to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

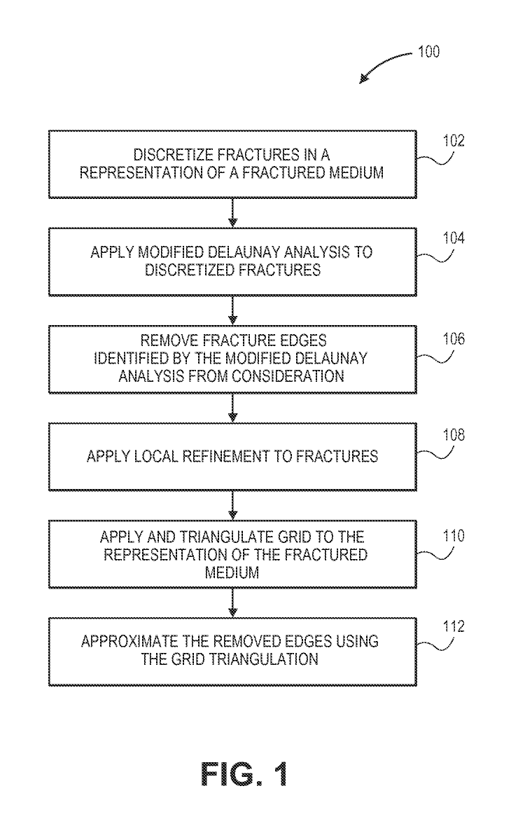

FIG. 1 illustrates a flowchart of a method 100 for discretizing a fractured medium, according to an embodiment. The method 100 may begin by discretizing the fractures in a representation of the fractured medium, as at 102. Further, the representation of the fractured medium may be a two-dimensional (“2D”) model, a three-dimensional (“3D”) model, or any other type of model. Accordingly, although the model described herein is a 2D model, other models are expressly contemplated. Further, such discretization at 102 can proceed according to any suitable type of discretization process. For example, discretization at 102 may include applying a mesh step for each fracture, which may be unique to the fracture, common among some or all fractures, or any other configuration.

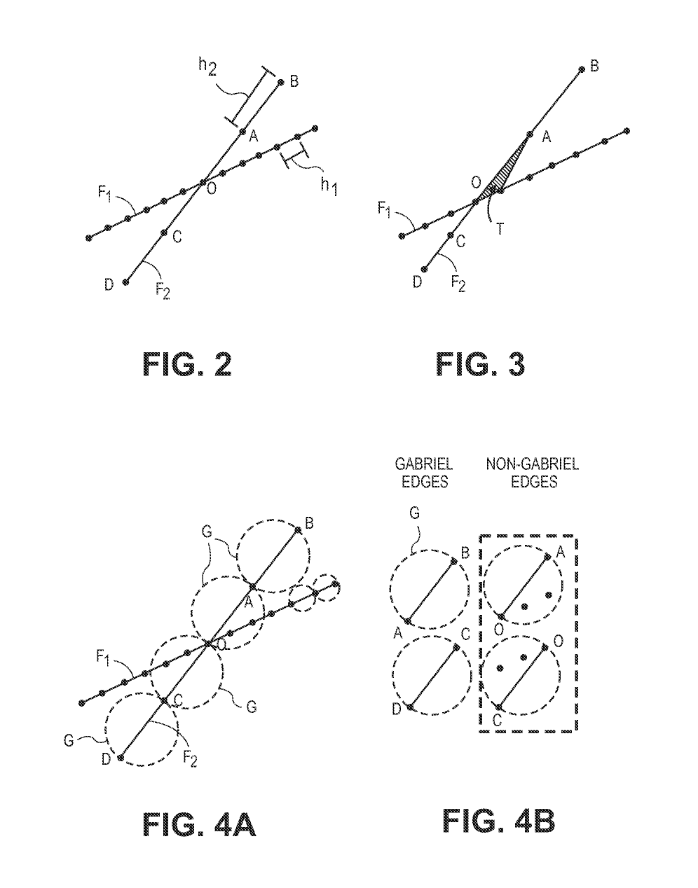

FIG. 2 illustrates such a discretization of two intersecting fractures F1, F2, in a two-dimensional representation of a fractured medium, according to an embodiment. As noted above, in a 2D discrete model, the fractures F1, F2 are represented as edges, as shown. In other types of models, the fractures F1, F2 can be represented as other types of discretized elements in the representation (e.g., facets). The two fractures F1, F2 may intersect at a point O. Further, the fracture F2 may also include points D, C, A, and B, while fracture F1 may include several points, as shown. In multi-dimensional representations of the fractures F1, F2, the points may be representative of lines along a plane, for example.

Each of the segments between the indicated points on fractures F1, F2 may represent discretized portions of the fractures F1, F2. Adjacent points on the fracture F1 may be separated by a mesh step h1, while adjacent points on the second fracture F2 may be separated by a mesh step h2. As can be appreciated, the mesh steps h1, h2 may not be equal. For example, the fractures F1, F2 may by differ in size by any multiple of one another, and may even be highly contrasted, such that they differ by one or more orders of magnitude in size. Different mesh steps h1, h2 may be appropriate to conserve computing resources while providing sufficient granularity to create a useful representation of the fractures F1, F2. In the illustrated example, the fracture F1 may have a considerably smaller length than the fracture F2, such that the model benefits from a smaller mesh step h1, while efficiently employing a larger mesh step h2. In other embodiments, the mesh steps h1, h2 may be equal or about equal.

Referring now to FIG. 3, as shown, discretizing the intersecting fractures F1, F2 with different mesh steps h1, h2 may result in one or more low-quality triangles T, if a triangulation is applied without correction. The term “low-quality triangles” is generally used herein to refer to “flat” triangles, that is, triangles in which two of the angles may approach zero while the third angle approaches 180 degrees. For example, a normalized triangle quality can be defined by the equation:

$$q = α \frac{A}{{a}^{2} + {b}^{2} + {c}^{2}} ,$$

where A is the area of the triangle; a, b, and c are the lengths of the sides of the triangle; and α=4\sqrt{3}, which serves as a normalizing coefficient. As such, an equilateral triangle has a quality of one, while a degenerate triangle, in which all three points lie on a single line, has a quality of zero, representing the lowest-quality triangle. Generally, low-quality triangles may provide reduced benefit to the model and thus quality is sought to be maximized.

Referring back to FIG. 1, with the fractures discretized, the method 100 can proceed to applying a modified Delaunay analysis to the fractures, as at 104. The modified Delaunay analysis can be or include application of the Gabriel criteria. Briefly, in a Gabriel analysis (i.e., an application of the Gabriel criteria), a circle may be defined using each pair of adjacent points of the fracture, with the line therebetween defining the diameter of the circle. Accordingly, the circle has a diameter that is the same as the relevant mesh step. FIG. 4A illustrates the Gabriel analysis applied to the two intersecting fractures F1, F2. As shown, for each line segment between points on the fracture F2, a Gabriel circle G is defined having a diameter equal to the mesh step h2.

Turning now to FIG. 4B, with the Gabriel circles G defined for each edge segment in fracture F2, the Gabriel criteria may be applied. According to the Gabriel criteria, an edge is a “non-Gabriel” edge if a point from the other fracture F1 is found within the circle G. In contrast, the edge is a Gabriel edge if no points from the other fracture F1 are found within the circle G. Accordingly, as shown, edges AB and CD are Gabriel edges, since no other points fall inside the Gabriel circles G thereof. On the other hand, edges OA and CO are non-Gabriel edges.

Although FIGS. 4A and 4B illustrate the Gabriel criteria being applied to the fracture F2, i.e., the fracture with the larger step h2, the Gabriel criteria may instead or additionally be applied to the fracture F1. Considering the two fractures F1, F2, a Gabriel analysis of the fracture F1 with the smaller mesh step h1 may be unnecessary; however, the fractured media (and/or a block thereof) in total may have a multiplicity of fractures, some of which may have a smaller mesh step than the mesh step h1, while others may have a larger mesh step than the mesh step h2. Accordingly, the Gabriel analysis may be applied to fracture F1, for example, to determine if any points on the fracture F1 present a potential for forming a low-quality triangle with points from a third fracture (not shown). Furthermore, the Gabriel analysis may be applied multiple times for each pair of fracture intersections.

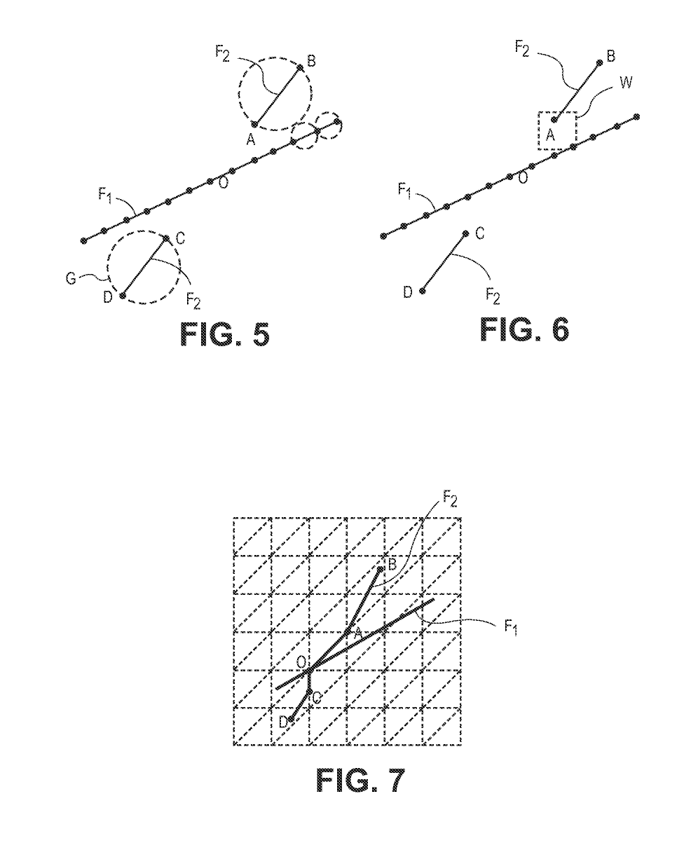

Returning to FIG. 1, the method 100 may proceed to removing edges identified by the modified Delaunay analysis (e.g., the non-Gabriel edges) from consideration, as at 106. The result may be a simplified fracture discretization, which is illustrated for the fractures F1, F2, according to an embodiment, in FIG. 5. As shown, edges OA and OC, previously identified as non-Gabriel edges, have been removed from the discretization of the fracture F2.

With the non-Gabriel edges removed from consideration in the representation, localized refinement may be applied, as at 108. However, in various embodiments, such localized refinement may be unnecessary and omitted. In at least one embodiment, the localized refinement may proceed using an analysis window W, as illustrated in FIG. 6. The analysis window W may be a square, as shown, or may be a rectangle, any other polygon, a circle, or the like.

In such a localized refinement technique, the analysis window W begins, e.g., in a corner of the domain (e.g., the block of the fractured media model), and moves through at least a portion of the domain of the fractured media representation in a step-wise manner. For example, the window W may analyze an area and then move horizontally, vertically, or both (or along another axis), to a new position, and analyze again. This process may repeat until the entire domain, or at least a portion thereof, has been analyzed.

If the window W encounters an area where one or more points from both fractures F1, F2 are present, as shown, the points may be moved to and collocated at, e.g., the center of the window W. This may remove one or more instances of two points on different fractures being in close proximity. In turn, this may reduce a potential for a low-quality Delaunay triangle appearing at this location, during subsequent triangulation. For example, as shown, point A of the first fracture F1 may be in proximity to one or more points on the second fracture F2, such that point A presents a potential for development of a low-quality triangle. To avoid such a situation, the method 100 may apply the local refinement at 108 to move point A and one or more points from the second fracture F2 to the middle of the window W.

Returning again to FIG. 1, with the non-Gabriel edges removed at 106, and at least some local refinement provided, if desired, at 108, the method 100 may proceed to applying a grid and triangulating the grid, as at 110. The grid may be triangulated using any type of triangulation method known, for example, a constrained or unconstrained Delaunay triangulation.

Briefly, a Delaunay triangle is a set of three points on the grid that together define a circumcircle that has no other points of the grid contained therein. An edge that is part of a Delaunay triangle is referred to as a Delaunay edge. A constrained Delaunay triangulation is a generalization of a Delaunay triangulation that forces certain segments into the triangulation. A constrained Delaunay triangulation is a “conforming Delaunay triangulation” if every constrained edge is a Delaunay edge, and it is a “conforming Gabriel triangulation” if every constrained edge is a Gabriel edge. The Gabriel property is generally more restrictive than the Delaunay property; accordingly, each conforming Gabriel triangulation may be a conforming Delaunay triangulation.

Therefore, with one of more of the non-Gabriel edges of the fractures F1, F2 removed (e.g., all of the non-Gabriel edges), the Delaunay criteria may be readily applied to the remaining points on the fractures F1, F2, resulting in, for example, a conforming Delaunay triangulation that avoids the low-quality triangles at the intersection of the fractures F1, F2.

With the triangulation complete, the method 100 may proceed to approximating the removed, non-Gabriel edges, as at 112. FIG. 7 illustrates the insertion of the approximations for the removed non-Gabriel edges. The approximation uses the lines established by the grid and the triangulation thereof, such that the approximated edges follow the established lines in the Delaunay triangulation. As such, the full discretization of the fractures F1, F2 may be reconstructed by the insertion of modified versions of the removed edges. The edges now, however, may be part of high-quality Delaunay triangles.

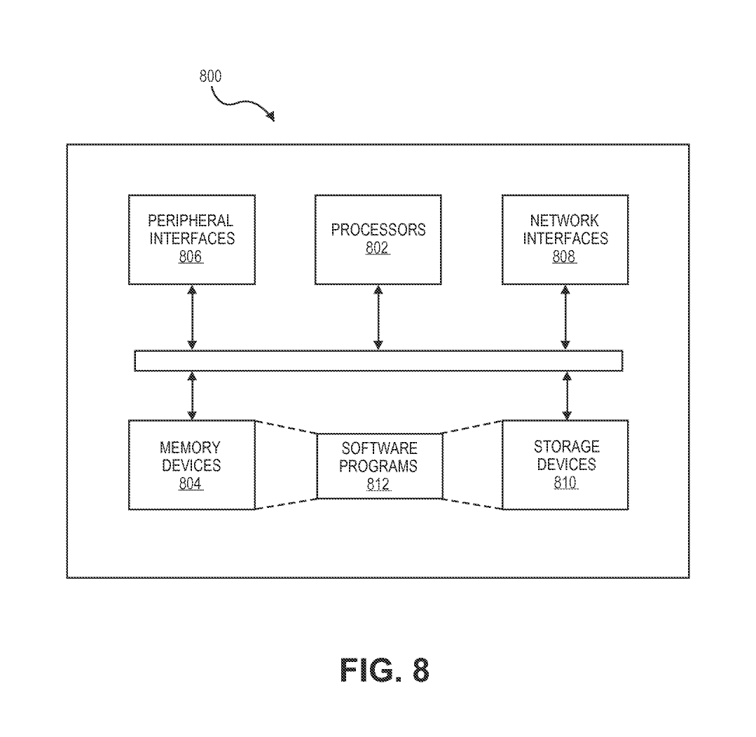

Embodiments of the disclosure may also include one or more systems for implementing one or more embodiments of the method 100. FIG. 8 illustrates a schematic view of such a processor system 800, according to an embodiment. The processor system 800 may include one or more processors 802 of varying core (including multiple core) configurations and clock frequencies. The one or more processors 802 may be operable to execute instructions, apply logic, etc. It will be appreciated that these functions may be provided by multiple processors or multiple cores on a single chip operating in parallel and/or communicably linked together.

The processor system 800 may also include one or more memory devices or computer-readable media 804 of varying physical dimensions, accessibility, storage capacities, etc. such as flash drives, hard drives, disks, random access memory, etc., for storing data, such as images, files, and program instructions for execution by the processor 802. In an embodiment, the computer-readable media 804 may store instructions that, when executed by the process, are configured to cause the processor system 800 to perform operations. For example, execution of such instructions may cause the processor system 800 to implement one or more portions and/or embodiments of the method 100 described above.

The processor system 800 may also include one or more network interfaces 806. The network interfaces 806 may include any hardware, applications, and/or other software. Accordingly, the network interfaces 806 may include Ethernet adapters, wireless transceivers, PCI interfaces, and/or serial network components, for communicating over wired or wireless media using protocols, such as Ethernet, wireless Ethernet, etc.

The processor system 800 may further include one or more display interfaces 808, for communication with a display screen, projector, etc. The processor system 800 may also include one or more peripheral interfaces 810 for communication with one or more keyboards, mice, touchpads, sensors, other types of input and/or output peripherals, and/or the like. In some implementations, the components of processor system 800 need not be enclosed within a single enclosure or even located in close proximity to one another, but in other implementations, the components and/or others may be provided in a single enclosure.

The memory devices 804 may be physically or logically arranged or configured to store data on one or more storage devices 810. The storage device 810 may include one or more file systems or databases in any suitable format. The storage device 810 may also include one or more software programs 812, which may contain interpretable or executable instructions for performing one or more of the disclosed processes. When requested by the processor 802, one or more of the software programs 812, or a portion thereof, may be loaded from the storage devices 810 to the memory devices 804 for execution by the processor 802.

Those skilled in the art will appreciate that the above-described componentry is merely one example of a hardware configuration, as the processor system 800 may include any type of hardware components, including any necessary accompanying firmware or software, for performing the disclosed implementations. The processor system 800 may also be implemented in part or in whole by electronic circuit components or processors, such as application-specific integrated circuits (ASICs) or field-programmable gate arrays (FPGAs).

### EXAMPLES

Reference to the following non-limiting examples may further the foregoing discussion.

### Example 1

### Three Mesh-Step Ratios

With reference to FIGS. 1-7, a 10 meter by 10 meter block of fractured media can be considered as an illustrative example of the method 100. Further, the ratio of the mesh steps h1, h2 of the fractures F1, F2, respectively, may be varied, for example, according to Table 1. As will be appreciated, three different mesh step ratios are considered in this example and are referred to respectively as cases 1, 2, and 3. Further, in this example, the domain boundary is discretized with a fixed mesh step (e.g., 1 meter) and the maximum number of vertices to be generated is fixed at 400.

TABLE 1
Mesh Step Ratios

| Case No. | h(F₁)/h(F₂) |
|---|---|
| Case 1 | 2 |
| Case 2 | 4 |
| Case 3 | 8 |

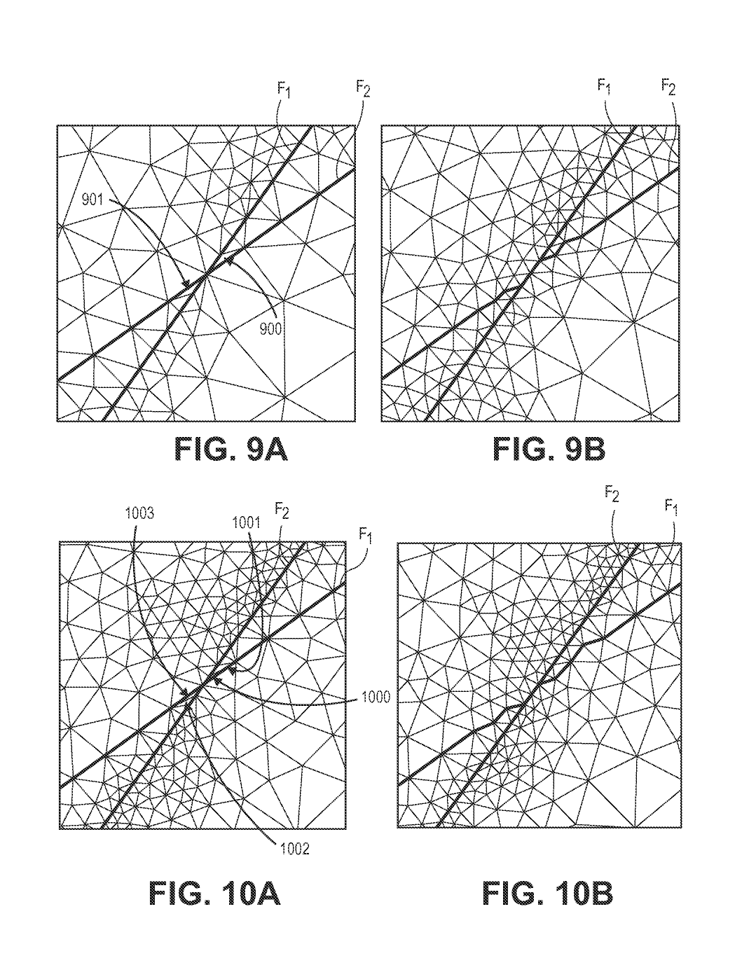

Using these three cases, the fractures F1, F2 may be discretized and the grid triangulated, using, for comparison, the traditional, Delaunay method and an embodiment of the method 100 disclosed herein. FIGS. 9A and 9B illustrate the results of the comparison for case 1, with FIG. 9A showing the discretization using the traditional Delaunay method and FIG. 9B showing the method 100 results. As shown, two low-quality triangles 900, 901, in FIG. 9A are avoided using the method 100, as shown in FIG. 9B, where the configuration at the intersection of the fractures is slightly modified to remove these critical triangles. Such minor changes in the fracture configurations have been shown to minimally affect the numerical results, as discussed later in the second example.

FIGS. 10A and 10B illustrate a comparison of the analysis for Case 2, with FIG. 10A showing the results of the traditional Delaunay triangulation and FIG. 10B showing the results of an embodiment of the method 100. As shown, the flexibility of the method 100 makes it suitable for higher-contrast fracture mesh steps. With a mesh step ratio of four, a plurality of low-quality triangles, e.g., triangles labeled 1001, 1002, 1003, 1004, are generated using the traditional Delaunay method as shown in FIG. 10A; however, the same or similar mesh quality as with the lower contrast ratios is maintained using an embodiment of the method 100, as shown in FIG. 10B.

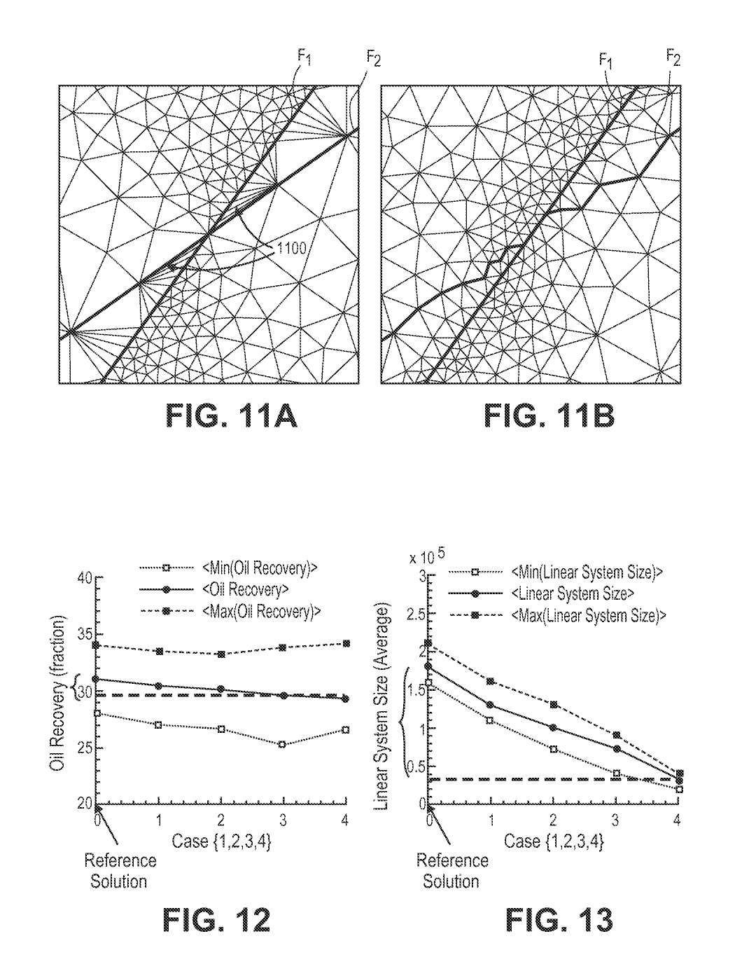

The results of increasing the ratio to eight (Case 3) further demonstrate a need for robust and flexible algorithms for such configurations. FIG. 11A illustrates results using a traditional Delaunay method, and FIG. 11B illustrates results of an embodiment of the method 100. In this test case the original approach generates a plurality of poor-quality degenerate triangles 1100, while the embodiment of the method 100 continues to produce a high mesh quality.

### Example 2

### Monte Carlo Simulations

Building from the three cases, a Monte Carlo simulation of 100 realizations of fracture networks generated by statistical distributions for fracture orientations, lengths, and positions further illustrates the method 100. In this example, the average number of fractures in the fractured media is 2,350. Further, the domain size is 200 m by 500 m, and a reference solution is calculated using a small mesh step equal to 0.5 m.

Four cases are considered for the fracture mesh step variation. In Case 1, the mesh step for each fracture is assigned randomly in the range of from 1 meter to 3 meters. In Cases 2-4 the mesh steps are assigned randomly in the ranges 1 meter to 4 meters, 1 meter to 5 meters, and 1 meter to 6 meters, respectively. Accordingly, the critical configurations generated are expected to be gradually more complex, proceeding from Case 1 to Case 4. The results are obtained by injecting water at a rate of 2.6×10⁻⁴ pore volume per day (PV/d) at the lower left corner of the domain to produce oil from the opposite corner. The fluid properties are given in Table 2.

TABLE 2
Relevant data for Example 2

| | |
|---|---|
| Domain Dimensions | 200 m × 500 m |
| Matrix | φₘₐ = 0.2, Kₘₐ = 1 md |
| Fracture | φ_{f} = 1, K_{f} = 10⁶ md, Thickness = 0.1 mm |
| Fluid | μₒ = 0.45 cp, ρₒ = 660 kg/m³, μ_{w} = 1 cp, |
| | ρ_{w} = 1000 kg/m³ |
| Injection Rate | 2.6 × 10⁻⁴ PV/d |

Where
ma: matrix,
f: fracture,
w: water,
o: oil,
μ: viscosity, and
ρ: density.

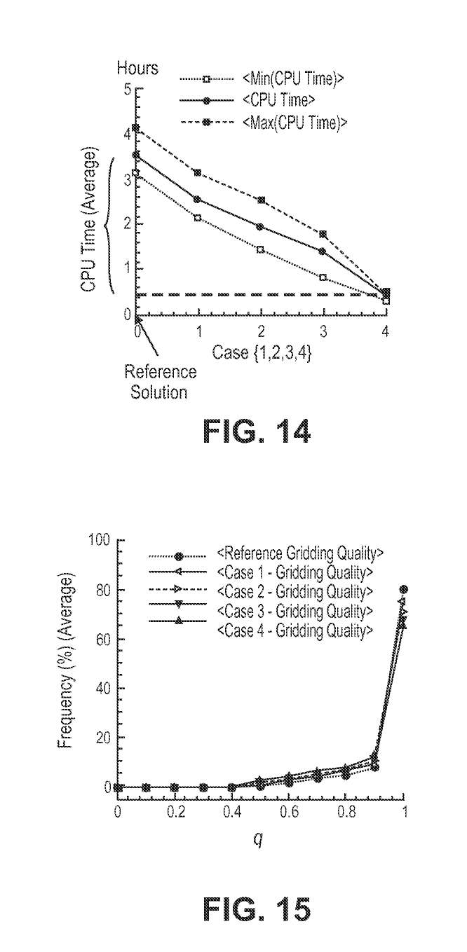

The oil recovery at 1 pore volume injected (PVI) was measured for the 100 realizations. The average, maximum, and minimum oil recoveries are depicted in FIG. 12. The reference solution is plotted at point zero. As the contrast in mesh steps increases from Case 1 to Case 4, the developed method 100 is shown to provide stable results, with a numerical error of about 1%. Increasing the mesh step decreases the linear system size and consequently the time to solve the linear system. The average, maximum, and minimum linear system size and computational time of the reference solutions and solutions obtained using the method 100 are shown in FIGS. 13 and 14. FIG. 13 shows that the linear system size decreases, on average, by about 85%, passing from the reference solution obtained on the fine grid to the solution obtained using the proposed method on the coarsest one. The same order of performance improvement is obtained for the average CPU time, as shown in FIG. 14.

The mesh maintains high quality for the exemplary cases using the method 100, as shown in FIG. 15. Further, most of the triangles are close to being equilateral even for large mesh step distributions. Accordingly, the proposed method has the ability to redistribute the grid elements around fractures while maintaining a high grid quality. All these results demonstrate the capability, consistency, and flexibility of the approach developed.

The foregoing description of the present disclosure, along with its associated embodiments, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 800 may be used to execute programs according to instructions received from another program or from another computing system altogether. Similarly, commands may be received, executed, and their output returned entirely within the processing and/or memory of the processor system 800. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents.

In the above description and in the below claims, unless specified otherwise, the term “execute” and its variants are to be interpreted as pertaining to any operation of program code or instructions on a device, whether compiled, interpreted, or run using other techniques. Also, in the claims, unless specified otherwise, the term “function” is to be interpreted as synonymous with “method,” and may include methods within program code, whether static or dynamic, and whether they return a value or not. The term “function” has been used in the claims solely to avoid ambiguity or conflict with the term “method,” the latter of which may be used to indicate the subject matter class of particular claims.

What is claimed is:

1. A method for modeling a fractured medium, comprising:
discretizing fractures in a representation of the fractured medium, wherein discretizing comprises defining points along the fractures and edges extending between adjacent points;
determining that at least one of the edges is a non-Gabriel edge;
removing the non-Gabriel edge from the representation;
approximating the removed non-Gabriel edge to generate an approximated edge; and
inserting the approximated edge into the representation.

2. The method of claim 1, further comprising applying a local refinement to the discretized fractures.

3. The method of claim 2, wherein applying the local refinement comprises:
defining a window in the representation, wherein the window has an interior;
determining that a first point of a first one of the discretized fractures and a second point of a second one of the discretized fractures are contained in the interior of the window; and
in response to determining that the first and second points are both contained in the interior of the window, collocating the first and second points in the window.

4. The method of claim 2, wherein applying the local refinement is subsequent to the removing the non-Gabriel edges from the representation.

5. The method of claim 1, further comprising triangulating a grid in the representation using a Delaunay method, wherein approximating the removed non-Gabriel edge comprises selecting an edge of the grid that is nearest to where the non-Gabriel edge was located prior to removal.

6. The method of claim 1, wherein determining that at least one of the edges is a non-Gabriel edge comprises:
defining a circle including adjacent points of at least one of the discretized fractures, wherein a diameter of the circle is equal to a distance between the adjacent points; and
determining that a point from another one of the discretized fractures is within the circle.

7. A system for modeling one or more fractured media, comprising:
one or more processors; and
one or more computer-readable media containing instructions that, when executed by the one or more processors, are configured to cause the system to perform operations comprising:
discretizing fractures in a representation of the fractured medium, wherein discretizing comprises defining points along the fractures and edges extending between adjacent points;
determining that at least one of the edges is a non-Gabriel edge;
removing the non-Gabriel edge from the representation;
approximating the removed non-Gabriel edge to generate an approximated edge; and
inserting the approximated edge into the representation.

8. The system of claim 7, wherein the operations further comprise applying a local refinement to the discretized fractures.

9. The system of claim 8, wherein applying the local refinement comprises:
defining a window in the representation, wherein the window has an interior;
determining that a first point of a first one of the discretized fractures and a second point of a second one of the discretized fractures are contained in the interior of the window; and
in response to determining that the first and second points are both contained in the interior of the window, collocating the first and second points in the window.

10. The system of claim 8, wherein applying the local refinement is subsequent to the removing the non-Gabriel edges from the representation.

11. The system of claim 7, wherein the operations further comprise triangulating a grid of the representation using a Delaunay method, wherein approximating the removed non-Gabriel edge comprises selecting an edge of the triangulated grid that is nearest to where the non-Gabriel edge was located prior to removal.

12. The system of claim 11, further comprising a display, wherein the operations further comprise:
displaying the grid on the display; and
displaying one or more modified fractures after approximating the removed non-Gabriel edge.

13. The system of claim 7, wherein determining that at least one of the edges is a non-Gabriel edge comprises:
defining a circle including adjacent points on at least one of the discretized fractures, wherein a diameter of the circle is equal to a distance between the adjacent points; and
determining that a point from another one of the discretized fractures is within the circle.

14. A computer-implemented method, comprising:
modeling a fractured media comprising a network of fractures in a model using a processor, wherein the fractures are represented as discretized elements, each of the discretized elements defining points separated by a mesh step, wherein a segment extends between each of the points;
applying a Gabriel criteria to at least a portion of the model using the points on at least one of the discretized elements;
determining that at least one segment between two points on the at least one discretized segment does not meet the Gabriel criteria;
removing the at least one segment from consideration in the model; and
approximating the at least one segment using a grid triangulation.

15. The method of claim 14, wherein:
modeling the fractured media in the model comprises modeling the fractured media in n-dimensions; and
representing the fractures in the model as the discretized elements comprises representing the discretized elements in n−1 dimensions.

16. The method of claim 15, wherein the model is two-dimensional and the discretized elements are linear edges.

17. The method of claim 14, wherein the mesh step of one of the discretized elements is different from the mesh step of at least one other one of the discretized elements.

18. The method of claim 14, wherein determining that at least one of the edges is a non-Gabriel edge comprises:
defining a circle including adjacent points on at least one of the discretized fractures, wherein a diameter of the circle is equal to a distance between the adjacent points; and
determining that a point from another one of the discretized fractures is within the circle.

19. The method of claim 14, wherein the operations further comprise applying a local refinement to the discretized fractures, comprising:
defining a window in the representation, wherein the window has an interior;
determining that a first point of a first one of the discretized fractures and a second point of a second one of the discretized fractures are contained in the interior of the window; and
in response to determining that the first and second points are both contained in the interior of the window, collocating the first and second points in the window.

20. The method of claim 19, wherein applying the local refinement is subsequent to the removing the at least one segment from the representation.
